(19) United States
(12) Patent Application Publication
(10) Pub. No.: US 2018/0155906 A1
(43) Pub. Date: Jun. 7, 2018

(54) SCALD PROTECTION UNIT

(71) Applicant: CeramTec GmbH, Plochingen (DE)

(72) Inventor: Matthias SELL, Walhausen (DE)

(21) Appl. No.: 15/571,748

(22) PCT Filed: May 2, 2016
(86) PCT No.: PCT/EP2016/059741

§ 371 Date: Nov. 3, 2017

(30) Foreign Application Priority Data
May 4, 2015 (DE) 102015208191.5

(51) Int. Cl. E03C 1/04; G05D 23/13; F16K 17/38

(52) U.S. Cl. CPC E03C 1/041; F16K 17/383; G05D 23/134

(57) ABSTRACT

The invention relates to a scald protection unit to be connected to a control cartridge (21) for mixer taps in the field of plumbing, wherein the scald protection unit has a housing (20) with a cold water inlet (1) for cold water, a hot water inlet (2) for hot water, a cold water outlet (6) and a mixed water outlet (9), and the cold water outlet (6) of the scald protection unit can be connected to a cold water inlet of the control cartridge (21) and the mixed water outlet (9) of the scald protection unit can be connected to a hot water inlet of the control cartridge (21). In order for it to be possible to preset the mixed water to a variable temperature and keep temperature changes in the inflow constant during operation, it is proposed according to the invention that the cold water inlet (1) of the scald protection unit is connected to the cold water outlet (6) of the scald protection unit by a cold water duct (14), the hot water inlet (2) of the scald protection unit opens into the inlet of a temperature control unit (4) via a hot water duct (15), a connecting duct (7) leads from the cold water duct (14) to the inlet of the temperature control unit (4), and the outlet of the temperature control unit (4) is connected to the mixed water outlet (9) of the scald protection unit via a mixed water duct (16).

The invention relates to a scald protection unit to be connected to a control cartridge for mixer taps in the field of plumbing, wherein the scald protection unit has a housing having a cold water inlet for cold water, a hot water inlet for hot water, a cold water outlet, and a mixed water outlet, and the cold water outlet of the scald protection unit can be connected to a cold water inlet of the control cartridge and the mixed water outlet of the scald protection unit can be connected to a hot water inlet of the control cartridge.

Currently on the market, there are existing systems that provide the consumer with protection against scalding, or the highest possible level of comfort. One of these systems limits the mixed water temperature in the outflow to a preset temperature, so as to ensure safety against scalding. Another safety feature is the shutting off of the hot water if, for example, the supply of cold water suddenly becomes unavailable. Areas of applications of such systems are kindergartens, hospitals, or retirement homes. Ensuring the above-mentioned features requires complex assembly of a large number of individual components, which is also reflected in the cost. Another disadvantage of these systems is the installation size with respect to the outer diameter and the overall height, which greatly limits the armature designer. There is a desire for systems that have a more compact design but still perform their function.

The invention addresses the problem of improving a scald protection unit according to the preamble of claim 1 so that the mixed water can be preset to a variable temperature, and temperature changes in the inflow can be kept constant during operation. In the event that the cold water should become unavailable, for any reason whatsoever, the temperature control unit shuts off the hot water, so as to preclude the possibility of scalding of the skin. According to the invention, the problem is solved by a scald protection unit having the features of claim 1.

Having the configuration be such that the cold water inlet of the scald protection unit is connected to the cold water outlet of the scald protection unit by a cold water duct, the hot water inlet of the scald protection unit opens into the inlet of a temperature control unit via a hot water duct, a connecting duct leads from the cold water duct to the inlet of the temperature control unit, and the outlet of the temperature control unit is connected to the mixed water outlet of the scald protection unit via a mixed water duct makes it possible to preset the mixed water to a variable temperature and keep temperature changes in the inflow constant during operation. In the event that the cold water should become unavailable, for any reason whatsoever, the temperature control unit shuts off the hot water, so as to preclude the possibility of scalding of the skin.

So that the water pressure is equalized in the inflow, a pressure equalization unit is arranged between the cold water inlet and hot water inlet, and the cold water duct and the hot water duct.

Preferably, the temperature control unit contains a wax expansion material element, a shape memory alloy, or an electrical temperature control element. For easy connection of the control cartridge, the scald protection unit preferably has a flange. This flange is designed so that the water paths from the scald protection unit are connected to the water paths in the control cartridge.

In a preferred embodiment, the housing of the scald protection unit is composed of a head part, a middle housing part, and a housing bottom, and a seal is located between each of these parts, wherein the cold water inlet and the hot water inlet are located in the housing bottom, the cold water duct and the hot water duct are located in the middle housing part, and the cold water outlet and the mixed water outlet are located in the head part. This reduces the number of parts needed and causes the scald protection unit to be sealed. Preferably, the middle housing part is composed of two parts that are connected to one another via a seal.

The following sections describe a scald protection unit according to the invention that should satisfy the market requirements.

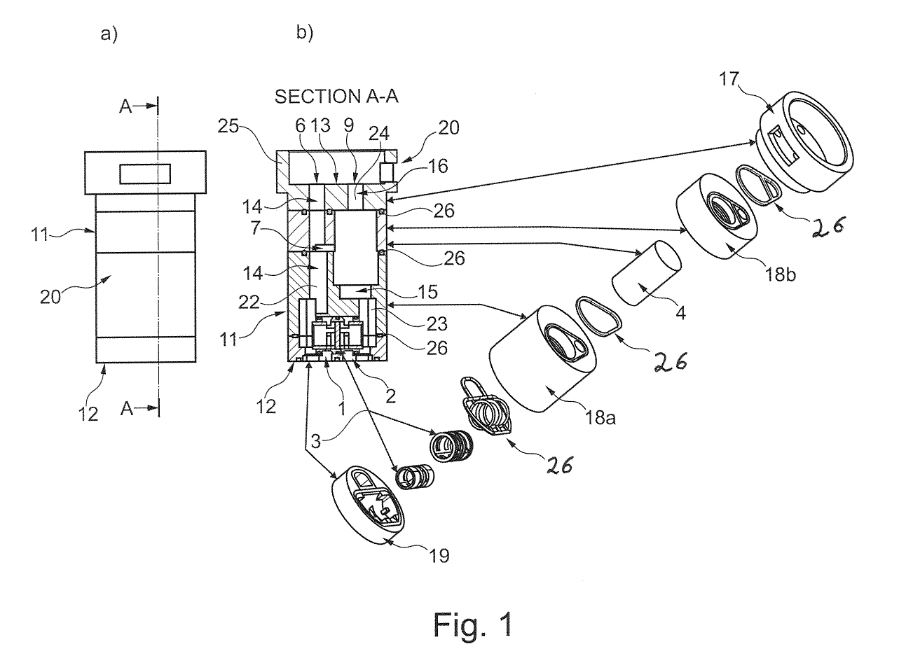

FIG. 1 illustrates a scald protection unit according to the invention, for sanitary cartridges. The supply of water to the scald protection unit for sanitary cartridges takes place at the positions 1 and 2, wherein 1 indicates the inlet hole for cold water and 2 indicates the inlet hole for hot water. Cold and hot water flow first through a known pressure equalization unit 3, so that, if the actual temperature control unit 4 has a pressure difference, equal amounts of cold and hot water are made available. After having passed the pressure equalization unit 3, the cold water flows through a cold water duct 14 to the cold water outlet 6, where the water could flow into a sanitary cartridge. FIG. 1 does not illustrate this sanitary cartridge, but the flange 25 onto which the control cartridge 21 is flanged. The cold water also flows, however, through a connecting duct 7, also called a bypass, to the temperature control unit 4. After having passed the pressure equalization unit 3, the hot water flows through a hot water duct 15 also to the temperature control unit 4. In this temperature control unit 4, hot and cold water are then mixed, flowing then through the mixed water duct 16 to the mixed water outlet 9, where the mixed water can then flow into a sanitary cartridge (not shown here). What is special about the temperature control unit 4 is that the mixed water can be preset to a variable temperature, and this temperature is kept constant during operation, e.g., in the event of pressure changes or temperature changes in the inflow. The control may be ensured, for example, by a wax expansion material unit, a shape memory alloy, or an electrical unit. In the event that the cold water should become unavailable, for any reason whatsoever, the temperature control unit 4 shuts off the hot water, so that the skin cannot be scalded. It is also important that the mixing of cold and hot water does not take place through ceramic sealing discs.

FIG. 1a illustrates an external view of a scald protection unit according to the invention for sanitary cartridges, and FIG. 1b shows a longitudinal view together with an exploded view of the individual parts. The scald protection unit according to FIG. 1 is composed of a cylindrical housing 20 having a closed circumferential wall 11, wherein the cylindrical housing and the closed circumferential wall are optional. The housing may also have a square shape, and the circumferential wall may also be interrupted, for example, by recesses, a lower connection side 12—lower as seen in the direction of flow of the flowing water—with a cold water inlet 1 for cold water and a hot water inlet 2 for the hot water, and an upper outlet side 13 with a cold water outlet 6 and a mixed water outlet 9. The housing 20 may be composed of a plurality of parts, as illustrated here, that are connected to one another via seals 26. The cold water inlet 1 is connected to the cold water outlet 6 via a cold water duct 14. The hot water inlet 2 is connected to the mixed water outlet 9 via two ducts 15 and 16, wherein the hot water inlet 2 is connected to a hot water duct 15, and the mixed water outlet 9 is connected to a mixed water duct 16. A temperature control unit 4 is arranged between the hot water duct 15 and the mixed water duct 16. An essential element of the invention is a connecting duct 7 that connects the cold water duct 14 to the temperature control unit 4. The scald protection unit illustrated in FIG. 1 has a known pressure equalization unit 3 that is arranged between the cold water inlet 1 and the cold water duct 14/between the hot water inlet 2 and the hot water duct 15. This pressure equalization unit 3 provides pressure equalization between the cold water duct 14 and the hot water duct 15. The upper outlet side 13 is connected to a standard control cartridge, or the control cartridge is set onto the outlet side 13. In the embodiment according to FIG. 1, the housing 20 is composed of a head part 17, a middle housing part 18 composed of the parts 18a and 18b, and a housing bottom 19. There is a seal located between each of these parts. The cold water inlet 1 and the hot water inlet 2 are located in the housing bottom 19. The cold water duct 14 and the hot water duct 15 are located in the middle housing part 18. The cold water outlet 6 and the mixed water outlet 9 are located in the head part 17.

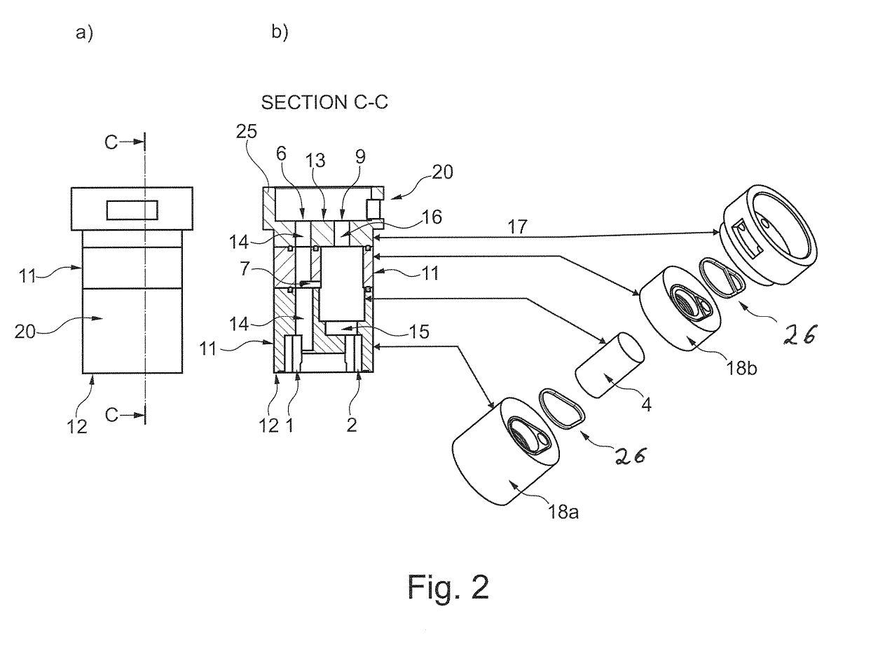

FIG. 2 illustrates the same scald protection unit as in FIG. 1, but without the pressure equalization unit 3. Like reference signs describe like parts.

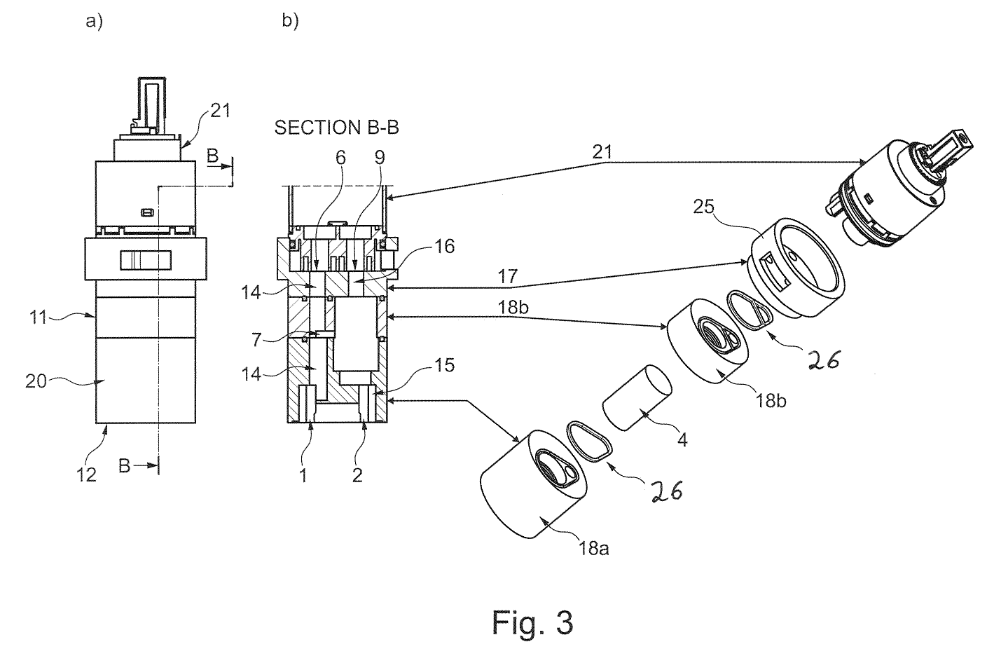

FIG. 3 illustrates the same scald protection unit as in FIG. 2, but without a control cartridge 21 set thereon.

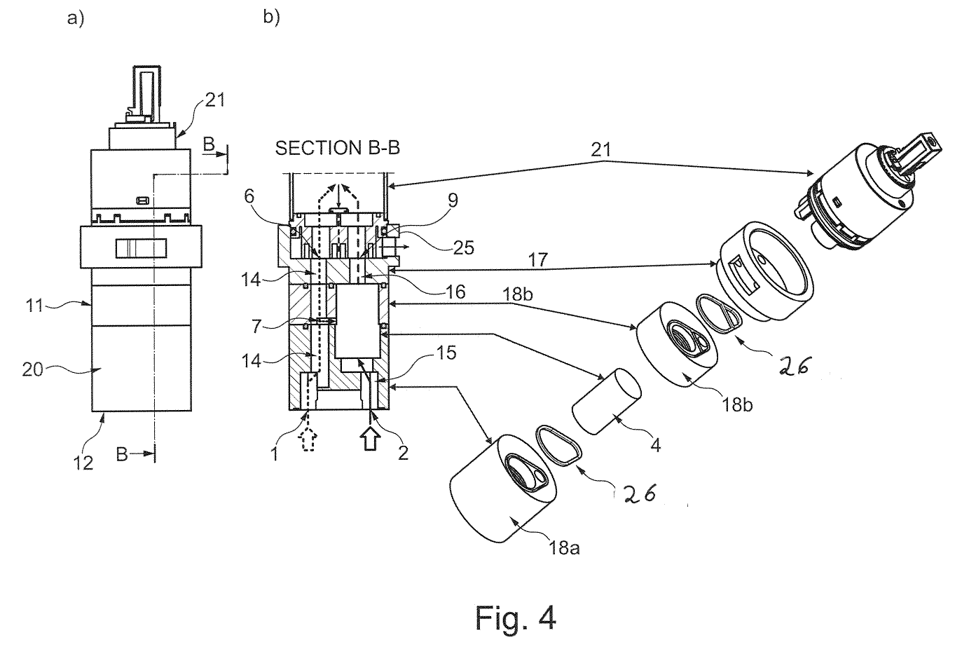

FIG. 4 illustrates the same scald protection unit as FIG. 3, with the control cartridge 21 set thereon, but in FIG. 4 the water paths 22, 23, 24 are marked. The water path 22 with cold water leads from the cold water inlet 1 into the control cartridge 21. The water path 23 for the hot water leads from the hot water inlet 2 to the temperature control unit 4. The water path 24 for the mixed water leads from the temperature control unit 4 into the cartridge 21.

The scald protection unit according to the invention is composed solely of plastic parts, metal parts, and seals.

1. A scald protection unit to be connected to a control cartridge for mixer taps in the field of plumbing, wherein the scald protection unit has a housing with a cold water inlet for cold water, a hot water inlet for hot water, a cold water outlet and a mixed water outlet, and the cold water outlet of the scald protection unit can be connected to a cold water inlet of the control cartridge and the mixed water outlet of the scald protection unit can be connected to a hot water inlet of the control cartridge, wherein the cold water inlet of the scald protection unit is connected to the cold water outlet of the scald protection unit by a cold water duct, the hot water inlet of the scald protection unit opens into the inlet of a temperature control unit via a hot water duct, a connecting duct leads from the cold water duct to the inlet of the temperature control unit, and the outlet of the temperature control unit is connected to the mixed water outlet of the scald protection unit via a mixed water duct.

2. The scald protection unit according to claim 1, wherein a pressure equalization unit is arranged between the cold water inlet and hot water inlet, and the cold water duct and the hot water duct.

3. The scald protection unit according to claim 1, wherein the temperature control unit contains a wax expansion material element, a shape memory alloy, or an electrical temperature control element.

4. The scald protection unit according to claim 1, wherein the scald protection unit has a flange for connecting the control cartridge.

5. The scald protection unit according to claim 1, wherein the housing of the scald protection unit is composed of a head part, a middle housing part, and a housing bottom, and a seal is located between each of these parts, wherein the cold water inlet and the hot water inlet are located in the housing bottom, the cold water duct and the hot water duct are located in the middle housing part, and the cold water outlet and the mixed water outlet are located in the head part.

6. The scald protection unit according to claim 5, wherein the middle housing part is composed of two parts that are connected to one another via a seal.
